(19) United States
(12) Patent Application Publication
(10) Pub. No.: US 2012/0268582 A1
(43) Pub. Date: Oct. 25, 2012

(54) USE OF THE OPTICAL ELEMENTS OF A HEAD-UP DISPLAY FOR THE CAMERA-BASED RAIN AND DIRT SENSING, DRIVING IDENTIFICATION OR FATIGUE DETECTION

(76) Inventor: Konrad Rothenhäusler, Achberg (DE)

(21) Appl. No.: 13/505,905

(22) PCT Filed: Oct. 16, 2010
(86) PCT No.: PCT/DE10/01219

§ 371 Date: Jul. 2, 2012

(30) Foreign Application Priority Data
Nov. 24, 2009 (DE) 10 2009 054 194.2

(51) Int. Cl. H04N 5/232; H04N 7/18

(52) U.S. Cl. 348/78; 348/148; 348/E07.085; 348/E05.045

(57) ABSTRACT

A vehicle having a device for generating a head-up display, wherein a camera including an image sensor and a focusing element is statically or dynamically introduced into the beam path of the head-up display via an optical or mechanical element. The focusing element is arranged in such a manner that a region of the outside of the windshield is imaged on the image sensor in a focused manner.

### CROSS REFERENCE TO RELATED APPLICATIONS

This application is the U.S. National Phase Application of PCT/DE2010/001219, filed Oct. 16, 2010, which claims priority to German Patent Application No. 10 2009 054 194.2, filed Nov. 24, 2009, the contents of such applications being incorporated by reference herein.

### FIELD OF THE INVENTION

The invention relates to a vehicle having a device for generating a head-up display, i.e., a device for the projection of information into the driver's field of view via the windshield.

### BACKGROUND OF THE INVENTION

Head-up displays are used for the projection of information into the driver's eye. In some cases, such projections enable the driver to refrain from looking at the instruments (speedometer, navigation display), whereby an additional time-consuming and strenuous accommodation of the eye (dynamic adaptation of the eye's refractive power) is made unnecessary. In most cases, the projection beam path of the head-up display into the driver's eye is to be adapted to the driver's height and position or to the size and the position of the defined eye region (eye box).

DE 10 2004 031 311 A1, which is incorporated by reference, shows a generic optical device for the representation of information on a projection surface with an image sensor matrix on which the pupil of a user can be imaged.

### SUMMARY OF THE INVENTION

An essential concept of an aspect of the invention is statically or dynamically introducing an additional camera comprising a focusing element and an image sensor into the beam path of a head-up display. The focusing element may be, e.g., a lens or an objective. Preferably, a CMOS or CCD chip is used as an image sensor.

The camera may be introduced into the optical system of the head-up display via a beam splitter or by means of a mechanically introduced camera, the latter being located on, e.g., a chopper wheel. Coupling a hinged mirror in (cf. reflex camera) is also possible. The camera could also be statically located in the beam path if a certain region of the projection of the head-up display does not have to be used. The camera may correspond to a cellphone camera.

An essential advantage of the invention consists in the fact that outstanding new camera functions can be realized by using the optical elements of the head-up display without much additional construction work. In the following, said functions will be described in greater detail.

A camera-based rain sensor can be realized by introducing the camera into the beam path. According to aspects of the invention, the focusing element of the camera is arranged in such a manner that a region of the outside of the windshield is imaged on the image sensor in a focused manner. The imaged region on the outside of the windshield corresponds to the region through which the virtual beam path of the head-up display passes.

The optical system of the head-up display is particularly used to obtain a relatively large sensor area on the windshield for rain detection. An evaluation of the camera images allows a reliable detection of rain or dirt particles on the windshield.

Prior-art rain sensors are arranged in the upper region of the windshield and hence observe a windshield part that does not correspond to the part of the windshield through which the driver of a motor vehicle looks. The sensor is not able to detect any local water (e.g., splashed water from a puddle etc.) and dirt accumulation present in the driver's field of view if they are not present in the field of view of the sensor as well. The sensor area of prior-art rain sensors is relatively small (about 2.5 cm²), which restricts reliable and fast rain detection. These rain sensors are visible from outside through a recess in the blackened part and partially spoil the design of the vehicle. Prior-art rain sensors, as stand-alone sensors, require space in a cramped zone of the vehicle, additional communications lines and supply lines as well as an eyehole in the blackened part of the windshield (footprint). Prior-art rain sensors in standard cars are sometimes interference-prone and annoy the driver of the motor vehicle by wrong or missing wiping.

The inventive way of rain sensing using the optical elements of a head-up display has great advantages over conventional optoelectronic or camera-based rain sensors. The sensor area is in the driver's field of view, wherein the sensor is not noticed by the driver. Rain and dirt are directly detected in the region that is most important to the driver. In comparison with prior-art rain sensor systems, the sensor area is relatively large so that faster and reliable detection is possible. For projection, the head-up display covers a windshield area of about 300 cm², whereas the currently used sensor area is about 2.5 cm².

The design of the solution presented herein is clearly advantageous since no sensor is visible from outside. The electronic components of the camera may be integrated into the electronic components of the head-up display, which saves costs and space. A camera-based rain sensor having a large field of view on the windshield can solve the problems of the prior-art rain sensors (e.g., drizzle) by means of an appropriately higher pixel resolution and also enables many other functions (e.g., detection of dry dirt).

A further advantage is the possibility of assessing the result of the wiping operation of the windshield cleaning system.

The camera-based rain sensor in the head-up display looks upwards so that it is largely protected from interferences caused by other road users.

In a preferred further development of an aspect of the invention, rain and dirt detection on the windshield is combined with a simultaneous observation of the driver's eye region by means of a camera. For this purpose, a bifocal focusing device is provided that operates according to, e.g., the principle of the refractive effect of a partially introduced plane-parallel plate in the convergent beam path, whereby two object planes can be achieved: one part of the footprint area on the windshield may be used to detect reflections of light in the raindrops in a first object plane and to drive the windshield wiper. The second object plane is the driver's eye region. In a first partial region, the image sensor delivers focused images of the outside of the windshield. In a second partial region, the image sensor delivers focused images of the driver's eye region. In the latter case, the windshield functions as a mirror. The beam path of the head-up display is used in an inverse direction. The second partial region of the image sensor receives light radiation from the eye box (eye region) of the driver. The arrangement of the focusing element allows the recognition and identification of the eyes and the surrounding areas of the face of the driver from the camera images. Driver identification may be advantageous in many ways (e.g., release of ignition, anti-theft device, child-proof lock, personalization of safety and comfort functions).

The driver identification system may be additionally supported by a modulated light source (e.g., voltage modulation of passenger compartment illumination). Thus, the driver can be quickly and reliably recognized before he or she starts the vehicle.

The observation of the driver's eye region may also be used for fatigue detection. In combination with a lane detection function, fatigue (as a reason for deviating from the traffic lane) can be detected more reliably and a dangerous situation can be defused by warning the driver appropriately (vibration, acoustic signals, light-induced pulse of passenger compartment illumination etc.).

The head-up display is capable of projecting light patterns onto the windshield. In a preferred embodiment, these light patterns may be used for rain detection, for example. Moreover, the air space above the windshield is advantageously illuminated by the head-up display. If additional illumination is required, it could be designed as IR illumination. If necessary, the head-up display may illuminate, in a clocked manner, the windshield part for improved rain or dirt detection. Generally, a part of the projected light of the head-up display is upwardly decoupled from the windshield. In order to prevent the driver from being disturbed by said windshield illumination, additional coupling-in of IR light may also be performed.

For example, rain detection may be illuminated by means of a cyclic light signal in the invisible spectral range (e.g., infrared) of the head-up display, said light signal covering the whole area. It is also possible to illuminate the area of the face (eye box) by means of infrared light (e.g., as a superimposed surface projection of an additional IR light source by the head-up display). In this manner, the driver's eyes can be cyclically observed while the vehicle is in motion.

In a preferred embodiment, a polarizing filter is at least partially arranged in the beam path between the optical or mechanical element and the image sensor.

For optimizing the observation of the eyes, a polarizing filter may be preferably provided in order to prevent light from shining from the surroundings (from above through the windshield) into the camera system. Said polarizing filter absorbs the light radiation that is not reflected via the windshield from the passenger compartment of the vehicle.

If the outside of the windshield is illuminated for rain detection, only a very small part of the light radiation is reflected from the inclined windshield into the eye region if no preferred polarizing direction of illumination is used. The reflected part is even smaller if that polarizing direction which is deliberately avoided by the light source of the head-up display is used in a calculated manner for illumination. In this manner, a maximum part of light passes the windshield, and light that is totally reflected or scattered back by raindrops or dirt is used for rain and dirt detection.

If the outside of the windshield and the eye region are simultaneously observed by means of a camera, the two regions are preferably illuminated by means of a polarizing filter with two partial regions with opposite polarizing directions, and the two regions are imaged onto the image sensor by means of a further polarizing filter with two partial regions with opposite polarizing directions.

So we propose a camera whose depth-of-field zone includes both the object plane “windshield” and the object plane “eye box”, wherein a partial polarizing filter coating between the objective and the sensitive image sensor surface is designed in such a manner that the polarizing filter effects for the defined image regions (eye box and windshield region for rain detection) are opposite to each other. By specifically illuminating the rain sensors with oppositely polarized light, making a distinction between the at least two different object planes can thus be supported in order to develop a reliable algorithm for object recognition. The polarizing filter/s may also be introduced dynamically since both object recognition processes do not have to be designed as fast processes.

The windshield area provided for rain detection may also be illuminated with visible light that is not or preferably oppositely polarized relative to the light radiation of the eye box.

The required camera may be used to determine the light in the surroundings and may deliver important sensor information for the head-up display, the air conditioning system, and the vehicle lighting system.

The sensor may also have further functions. For example, it may function as a communication interface between man and vehicle. Possible applications may include, e.g., opening the vehicle by, e.g., placing a card with an imprinted code on the windshield footprint of the head-up display or by having a fingerprint evaluated by the camera. Said opening function is enabled by the camera being focused on the outside of the windshield.

In an advantageous realization, the vehicle has at least one of the following assistance functions on the basis of an evaluation of the data from the image sensor: driver recognition, fatigue detection, rain/dirt detection.

Exemplary embodiments and drawings will be described in the following.

### BRIEF DESCRIPTION OF THE DRAWINGS

The invention is best understood from the following detailed description when read in connection with the accompanying drawing. Included in the drawing is the following figure:

FIG. 1 shows the beam path of a head-up display.

FIG. 2 additionally shows the beam path when an image is formed on an image sensor via a beam splitter.

### DETAILED DESCRIPTION OF THE PREFERRED EMBODIMENTS

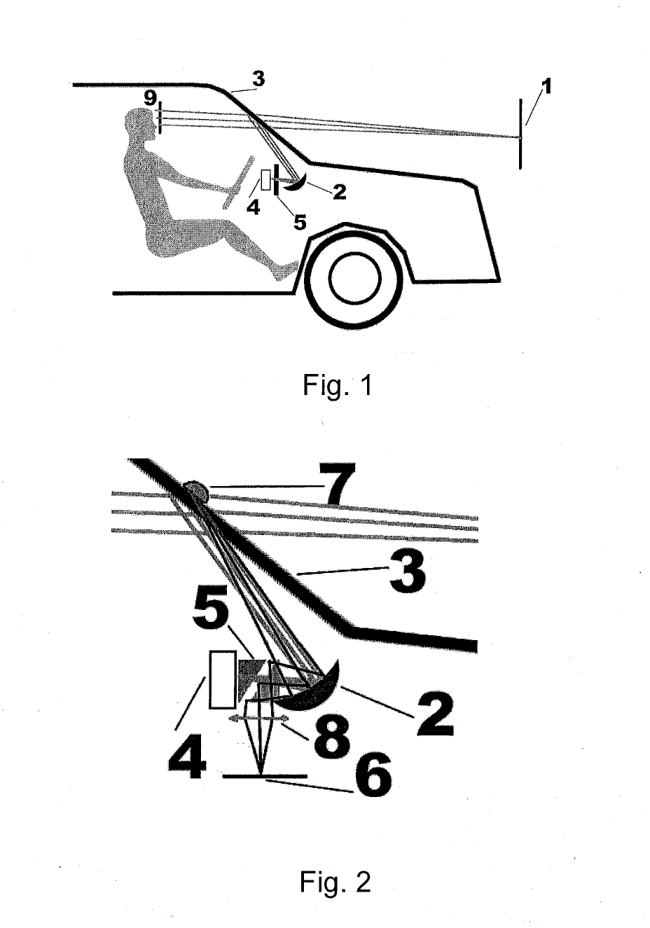

FIG. 1 shows a vehicle having a device for generating a head-up display. A light source (light emitter) (4) generates the electromagnetic radiation that the driver can see in the form of a display (1) in the region in front of the windshield. A concave mirror (deflection mirror or free-form mirror) (2) effects a divergence of the radiation and deflects the diverging radiation towards the windshield (3). The greater part of the radiation is reflected from the windshield (3) into the interior of the vehicle and reaches the driver's eye region (9). The driver sees the virtual image (1) in the region in front of the windshield.

The region (5) between the light source (4) and the deflection mirror (2) shown in FIG. 1 is a possible mounting position for an additional optical or mechanical element (5) for beam splitting or beam deflection.

In FIG. 2, an additional optical element (5) in the form of a beam-splitting prism has been introduced into the beam path of the head-up display according to FIG. 1 within the region shown in FIG. 1. A focusing element (8) and an image sensor (6) are arranged below the beam-splitting prism. A raindrop (7) located on the windshield (3) in the region of the virtual beam path of the head-up display is imaged onto the image sensor (6) by the focusing device (8) via the deflection mirror (2) of the head-up display and via the beam-splitting prism (5). The raindrop (7) is illuminated by a small part of the electromagnetic radiation of the head-up display that is not reflected from the windshield (3) into the interior of the vehicle. In this exemplary embodiment, the focusing device (8) is adjusted in such a manner that the region (7) of the outside of the windshield (3) through which the virtual beam path of the head-up display passes is imaged on the image sensor (6) in a focused manner.

The image data of the camera (6, 8) can be used for the detection of the presence of raindrops (7) or dirt particles on the windshield (3) and for the generation of a signal for activating the windshield wipers or a windshield washing program.

Advantageously, the rain sensor is not visible from outside although the region of the windshield in which rain or dirt particles is/are detected is directly located in the driver's field of view.

### LIST OF REFERENCE NUMERALS

1 virtual image
2 concave mirror
3 windshield
4 light source
5 optical/mechanical element for beam splitting/beam deflection
6 image sensor
7 raindrop on the windshield in the region of the virtual beam path of the head-up display
8 focusing element
9 eye region

1.-6. (canceled)

7. A vehicle having a device for generating a head-up display, wherein a camera comprising an image sensor and a focusing element is statically or dynamically introduced into a beam path of the head-up display via an optical or mechanical element, wherein the focusing element is arranged in such a manner that a region of an outside of the windshield is imaged on the image sensor in a focused manner.

8. The vehicle according to claim 7, wherein the focusing element allows bifocal imaging, in which the driver's eye region is imaged in a first partial region of the image sensor and a region of the outside of the windshield is imaged in a second partial region of the image sensor in a focused manner.

9. The vehicle according to claim 8, wherein the first partial region and second partial region are illuminated by a polarizing filter with two partial regions with opposite polarizing directions, and the two regions are imaged onto the image sensor by means of a further polarizing filter with two partial regions with opposite polarizing directions.

10. The vehicle according to claim 7, wherein infrared illumination of the region of the outside of the windshield imaged on the image sensor or of the driver's eye region is provided and the image sensor is capable of detecting infrared radiation.

11. The vehicle according to claim 7, wherein a polarizing filter is at least partially arranged in the beam path between the optical or mechanical element and the image sensor.

12. The vehicle according to claim 7 having at least one of the following assistance functions on the basis of an evaluation of the data from the image sensor: driver recognition, fatigue detection, and rain/dirt detection.
